(19) United States
(12) Patent Application Publication
(10) Pub. No.: US 2010/0048121 A1
(43) Pub. Date: Feb. 25, 2010

(54) UNDER-FLOOR PLIABLE AIR DUCT/DISPERSION SYSTEMS

(76) Inventors: Jeffrey Klopfenstein, Dubuque, IA (US); Kevin J. Gebke, Dubuque, IA (US); Nicolas B. Paschke, Mequon, WI (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/196,999

(22) Filed: Aug. 22, 2008

(51) Int. Cl. F24F 7/04; B23P 19/04

(52) U.S. Cl. 454/186; 29/700

(57) ABSTRACT

An under-floor HVAC system for a building includes a pliable air duct lying upon a subfloor. A matrix of pedestals resting upon and extending upward from the subfloor supports a set of floor panels, which thus creates a plenum between the subfloor and the set of floor panels. The air duct extends through the plenum to convey conditioned air from a supply air duct to a series of registers in the floor panels. The registers disperse the conditioned air to a room or area just above the panels. To help keep the air duct from repeatedly extending, retracting, and otherwise sliding freely along the subfloor in response to changes in air duct pressure, the air duct is held taut by anchoring a distal downstream end of the duct to one or more of the floor-supporting pedestals. Various air duct configurations can be assembled from a predefined assortment of duct components.

### FIELD OF THE DISCLOSURE

This patent generally pertains to HVAC systems (heating, ventilating and air conditioning systems) and, more specifically, to under-floor air ducts.

### BACKGROUND

To heat, cool, filter, dehumidify, ventilate or otherwise condition the indoor air of a comfort zone, such as a room or area in a building, the floor of some buildings have a supply air plenum between a subfloor and a matrix of floor panels that are elevated about one or two feet just above the subfloor. The floor panels, which are usually supported by a matrix of pedestals extending upward from the subfloor, provide the surface upon which the building occupants walk and furniture is set.

With an under-floor HVAC system, a supply air duct discharges fresh or conditioned supply air into the plenum, which in turn conveys the supply air to a series of supply air registers or openings in the floor panels. The registers release the supply air from within the plenum up into the comfort zone. The general goal is to have a sufficient number of properly placed registers such that the supply air rises evenly up through the comfort zone for the benefit of the occupants at floor level. As the supply air continues to rise above the occupants, the eventually used or less-than-fresh air approaches the ceiling to where one or more return air ducts extracts the air for reconditioning and/or exhausting outdoors.

One problem, however, is that if the air from the supply air duct has to travel a great distance to a remote register, the supply air might lose much of its desirable temperature by heat transfer with the subfloor, particularly if the subfloor is made of concrete with a high specific heat. Also, as the supply air travels radially from the supply air duct, the air expands and loses much of its velocity. Additional velocity is lost when less remote registers release air before that air can reach more distant registers. Thus, remote registers receiving lower pressure air tend to release disproportionately less air to the comfort zone than registers that are closer to the supply air duct.

To avoid these problems, some under-floor HVAC systems include a relatively rigid sheet metal air duct or a pliable tubular air duct that is installed under-floor in the plenum between the subfloor and the floor panels. Under-floor air ducts help channel supply air along a more directed route from the supply air duct to certain remote registers. A drawback of such installations, however, is that under-floor air ducts, particularly pliable ones, tend to retract and extend longitudinally in response to changes in duct pressure. The resulting sliding movement can create noise and abrade the duct material. Moreover, there are endless possible floor layouts with various supply airflow needs, thus it can be difficult and expensive to custom build numerous air duct systems to meet all those needs.

### BRIEF DESCRIPTION OF THE DRAWINGS

FIG. 1 is a top view of an example of an under-floor air duct system with a plurality of floor panels omitted to show underlying features of the system.

FIG. 2 is a cross sectional view taken along line 2-2 of FIG. 3.

FIG. 3 is a top view similar to FIG. 1 but with most of the floor panels installed.

FIG. 4 is an exploded top view illustrating an example of an under-floor method.

### DETAILED DESCRIPTION

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness. Additionally, several examples have been described throughout this specification. Any features from any example may be included with, a replacement for, or otherwise combined with other features from other examples.

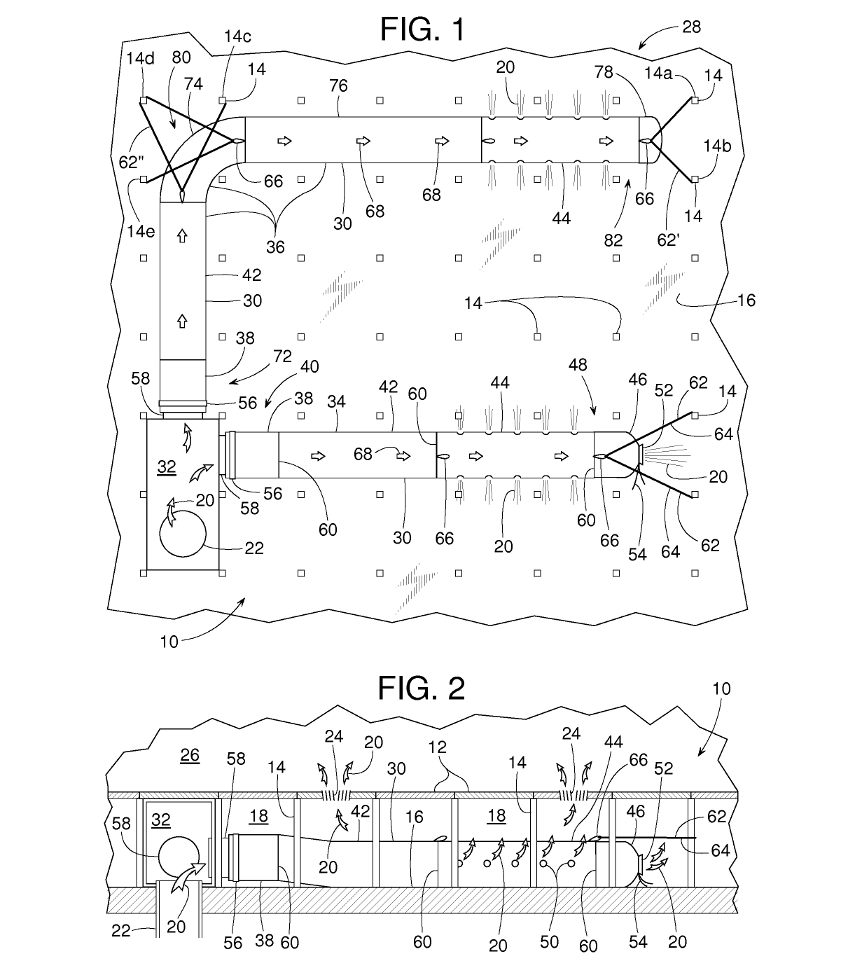

A building floor 10, shown in FIGS. 1-3, includes a plurality of generally rigid floor panels 12 supported by a matrix of pedestals 14 that extend upward from a subfloor 16. The space between subfloor 16 and floor panels 12 provides a plenum 18 for conveying fresh supply air 20 from a supply air duct 22 to a series of supply air registers 24 in floor panels 12. Supply air 20 discharging upward through air registers 24 helps condition or ventilate a comfort zone 26 that is just above floor panels 12. Comfort zone 26 may be any designated zone supplied with air from a HVAC system, and that may be occupied by people.

To create an air duct system 28 that ensures supply air 20 is evenly distributed or properly apportioned across comfort zone 26, a distribution air duct 30 is installed within plenum 18. Distribution air duct 30 receives supply air 20 from a supply air chamber 32 fed by supply air duct 22 and conveys supply air 20 to wherever it is needed. Distribution air duct 30 is particularly useful for conveying supply air 20 to remote areas of comfort zone 26 that are quite distant from supply air chamber 32.

For sake of example, distribution air duct 30 is shown to include two runs, a straight run 34 and a longer L-shaped run 36; however, any number of runs, shapes or branches of runs are well within the scope of the methods and apparatus described herein. Although the actual construction, assembly and installation of distribution air duct 30 may vary, example runs 34 and 36 are tubes of pliable material, thus distribution air duct 30 generally inflates when pressurized by supply air 20 and tends to collapse (i.e., sag or deflate) when supply air 20 is turned off. The pliable material of distribution air duct 30 can be cloth fabric, sheets of plastic or rubber, porous, nonporous, perforated, nonperforated, and various combinations thereof.

Run 34 of distribution air duct 30 comprises a pliable tubular inlet collar 38 at a proximal end 40 of run 34, a first duct segment 42 that can be porous or nonporous, a second duct segment 44 that is preferably perforated although not necessarily so, and an end cap 46 at a distal end 48 of run 34. To release more supply air 20 near distal end 48, second duct segment 44 includes a series of discharge air perforations 50. First and second duct segments 42 and 44 are examples of an upstream tubular wall section and a downstream tubular wall section, respectively, with first duct segment 42 being more air permeable than second duct segment 44. Alternatively, or to release even more supply air 20 near distal end 48, end cap 46 can be provided with a discharge opening 52. The amount of supply air 20 discharged through end cap 46 can be adjusted by tightening or loosening a drawstring 54 at the throat of discharge opening 52. An example of end cap 46 can be found in U.S. Pat. No. 6,558,250.

To assemble run 34, a strap clamp 56 fastens inlet collar 38 to a rigid tubular flange 58 that conveys supply air 20 from supply air chamber 32 to the interior of run 34. To balance or apportion the airflow between runs 34 and 36, a conventional baffle (not shown) can be installed within tubular flange 58. Inlet collar 38, first and second duct segments 42 and 44, and end cap 46 can be joined end-to-end via any suitable fastener 60 including, but not limited to, a zipper running circumferentially around the adjoining pieces. Once assembled, run 34 of distribution air duct 30 can simply rest upon subfloor 16 for vertical support.

For horizontal support, however, or to prevent run 34 from sliding around or repeatedly extending and retracting due to changes in air duct pressure, a fastener 62 preferably connects distal end 48 to one or more pedestals 14. In some examples, fastener 62 comprises an elongate pliable member 64 (e.g., cable, strap, chain, rope, cord, wire, etc.) that connects a loop 66 (e.g., hook, snap connector, etc.) that is sewn or otherwise attached to one end of second duct segment 44. To provide run 34 with horizontal support in two dimensions, elongate pliable member 64 can be attached to two or more pedestals 14 in a generally V-shaped layout as shown in FIG. 1. In the V-shaped layout, fastener 62 can be two individual elongate members or a single elongate member with two legs.

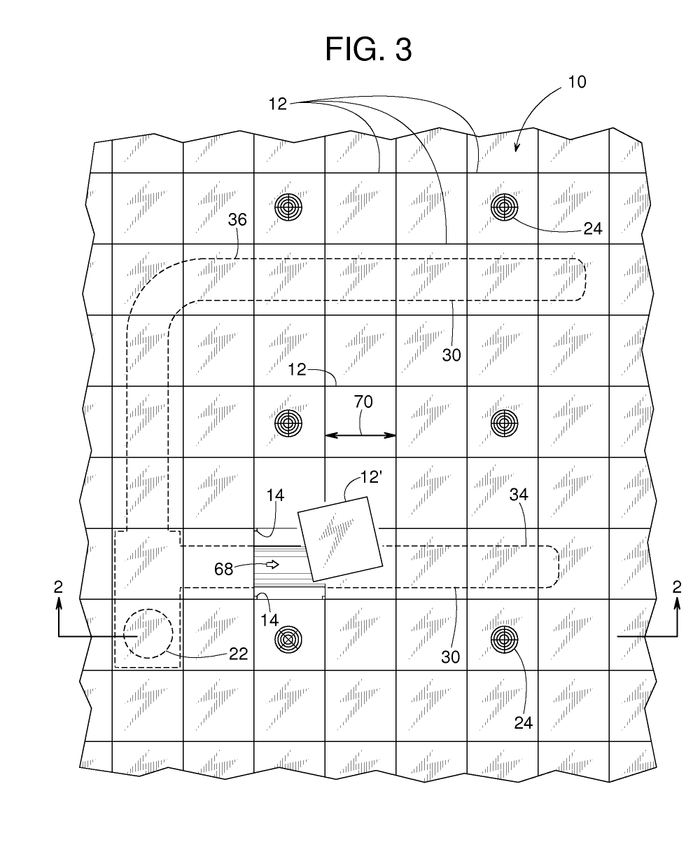

To aid service personnel in maintaining or troubleshooting air duct system 28, distribution air duct 30 preferably includes a series of decals 68 (e.g., label, tag, visual marker, sign, arrowhead, etc.) that are distributed along the upper surface of distribution air duct 30. Decals 68 are best placed at intervals that correspond to the standard dimension of floor panels 12 so that whenever any floor panel 12 above distribution air duct 30 is lifted for service reasons, such as panel 12′ of FIG. 3, at least one decal 68 is visible. Two feet is a common standard width 70 for floor panels 12, thus the separation between decals 68 is preferably at most two-foot.

Run 36 is similar in construction to run 34. Run 36 comprises inlet collar 38 at a proximal end 72 of run 36, first duct segment 42, a right-hand tubular elbow 74 made of a pliable material, a relatively long duct segment 76 that can be porous or nonporous, second duct segment 44, and a closed end cap 78. Similar to run 34, strap clamp 56 fastens inlet collar 38 to tubular flange 58, and the various pliable duct segments 42, 44 and 76, inlet collar 38 and elbow 74 can be joined end-to-end by way of zippers.

Run 36 includes a first distal end 80 at elbow 74 and a second distal end 82 at end cap 78. Fastener 62′ and loop 66 anchors second distal end 82 to pedestals 14a and 14b, and fastener 62″ anchors elbow 74 to pedestals 14c, 14d and 14e. Fasteners 62′ and 62″ each can be made of a single elongate member with multiple legs or multiple individual elongate members.

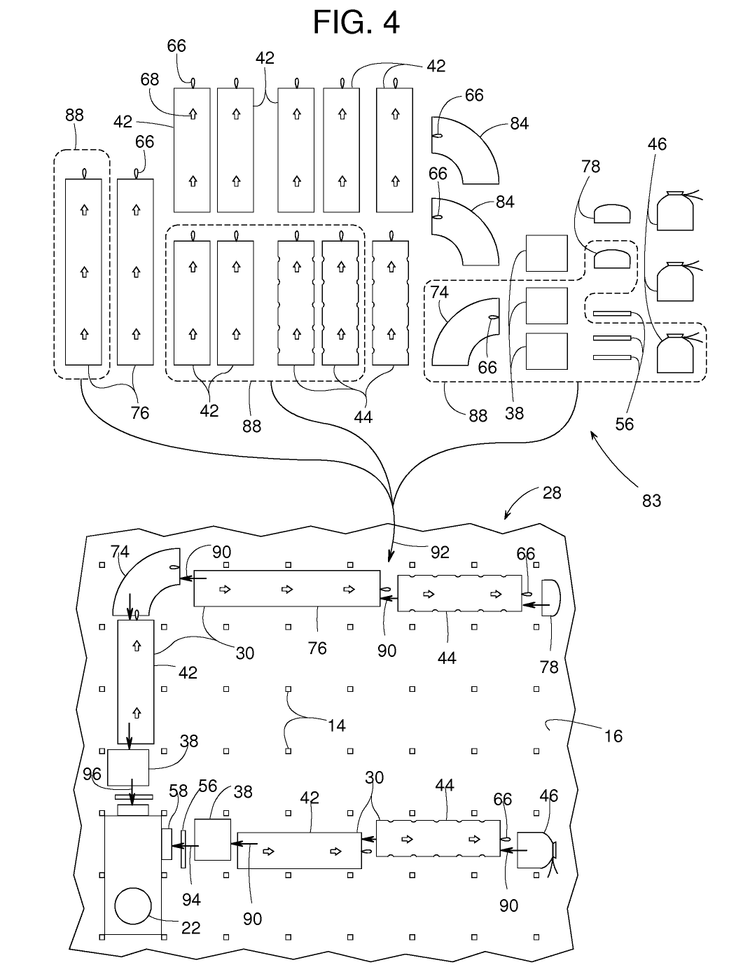

Since there are endless possible floor layouts with various supply airflow needs, it can be difficult and expensive to custom build numerous air duct systems to meet all those needs. To address this problem, air duct system 28 preferably is assembled from a predefined assortment of duct segments 83, as shown in FIG. 4. For sake of example, assortment 83 includes two predefined long duct segments 76, seven predefined short first duct segments 42, three predefined second duct segments 44, one right-hand elbow 74, two left-hand elbows 84, three inlet collars 38, two closed end caps 78, three strap clamps 56, and three open end caps 46. The terms “long” and “short” as they relate to duct segments 42 and 76, simply means that one segment of predefined length is longer than the other. It should be noted that right-hand elbow 74 and left-hand elbow 84 are unique and distinguishable from each other by virtue of the location of loop 66 and/or the orientation of their zippered joints.

To create the two-run distribution air duct 30 after defining assortment 83, one strategically chooses a collection 88 of duct segments from assortment 83, wherein collection 88 is depicted by the parts encircled by the dashed lines in FIG. 4. Arrows 90 represents the assembling of collection 88 to create distribution air duct 30, and arrow 92 represents installing of distribution air duct 30. The assembling (arrow 90) of collection 88 and the installing (arrow 92) of air duct 30 do not have to be performed in any particular order. The assembling (arrow 90) of collection 88 and the installing (arrow 92) of air duct 30 can be done in any sequential order or done generally simultaneously. Arrows 94 and 96 each represent coupling proximal ends 40 and 72 to supply air duct 22 such that supply air 20 from supply air duct 22 can pass in series through, for example, proximal end 40, toward distal end 48, out from within distribution air duct 30, into plenum 18, up through supply air register 24 and into comfort zone 26 Once distribution air duct 30 is assembled, fasteners 62 being shown taut in FIGS. 1 and 2 illustrate pulling distribution air duct 30 in tension generally between supply air duct 22 and at least one pedestal 14.

The just-described modular method of assembling a distribution air duct is best achieved when duct segments 42, 44 and 76 are of predefined lengths that are substantially whole number multiples of standard width 70. If, for instance, standard width 70 is two feet, predefined short first duct segment 42 can be two, four, six, eight, . . . 2n feet long. The same is true for predefined long duct segment 76 but with long duct segment 76 being longer than short first duct segment 42.

At least some of the aforementioned examples include one or more features and/or benefits including, but not limited to, the following:

In some examples, an air duct system for a building comprises a collection of pliable tubular segments that are assembled end-to-end to create a distribution air duct that rests upon a subfloor below a plurality of removable floor panels. To help keep the distribution air duct from sliding freely along the subfloor, the air duct is held taut by anchoring a distal downstream end of the duct to at least one and preferable two or three pedestals that help support the floor panels above the subfloor.

In some examples, a distribution air duct is assembled from a collection of pliable tubular segments chosen from a predefined assortment of segments, wherein the assortment of segments are of discrete lengths based upon the width of a standard floor panel.

In some examples, a distribution air duct made of one or more pliable tubes rests directly upon a subfloor, thereby eliminating the need for any overhead mounting support, such as an overhead cable or track.

In some examples, a pliable distribution air duct includes a series of flow direction indicators that are distributed along the length of the duct at a spacing interval that corresponds to the width of a standard floor panel.

In some examples, an under-floor distribution air duct includes an end cap with an adjustable discharge opening.

Although certain example methods, apparatus and articles of manufacture have been described herein, the scope of the coverage of this patent is not limited thereto. On the contrary, this patent covers all methods, apparatus and articles of manufacture fairly falling within the scope of the appended claims either literally or under the doctrine of equivalents.

1. An air duct system for conveying air to a comfort zone of a building, wherein the building includes a subfloor, a plurality of pedestals on the subfloor, a plurality of floor panels supported by the plurality of pedestals such that the plurality of floor panels is above the subfloor to define a plenum therebetween, a supply air duct below the plurality of floor panels, and a supply air register on the plurality of floor panels, the air duct system comprising:
a distribution air duct installable within the plenum underneath the plurality of floor panels so as to rest upon the subfloor, the distribution air duct is made of a pliable material such that the distribution air duct is inflatable and collapsible, the distribution air duct includes a proximal end and a distal end, the proximal end is connectable to the supply air duct such that air from the supply air duct can pass in series through the proximal end, toward the distal end, out from within the distribution air duct, into the plenum, up through the supply air register, and into the comfort zone; and
a fastener adapted to connect the distal end to a first pedestal of the plurality of pedestals such that the distribution air duct can be held in tension between the supply air duct and the first pedestal.

2. The air duct system of claim 1, wherein the fastener includes an elongate pliable member.

3. The air duct system of claim 1, wherein the fastener holds the distribution air duct in tension between the supply air duct and the first pedestal.

4. The air duct system of claim 1, wherein the fastener also connects the distal end to a second pedestal of the plurality of pedestals.

5. The air duct system of claim 1, wherein the distal end is an elbow.

6. The air duct system of claim 1, wherein the distal end defines an adjustable opening for exhausting air into the plenum.

7. The air duct system of claim 1, wherein the distribution air duct comprises an upstream tubular wall section adjacent the proximal end and a downstream tubular wall section adjacent the distal end, and the downstream tubular wall section is more air permeable than the upstream tubular wall section.

8. The air duct system of claim 1, further comprising a plurality of decals on an upper surface of the distribution air duct, wherein the plurality of decals are spaced at intervals that are less than a width of each of the plurality of floor panels and wherein the plurality of decals indicate an airflow direction, the plurality of decals are substantially covered by the plurality of floor panels when the plurality of floor panels are supported by the plurality of pedestals.

9. An air duct system for conveying air to a comfort zone, the air duct system comprising:
a subfloor;
a plurality of pedestals on the subfloor;
a plurality of floor panels supported by the plurality of pedestals such that the plurality of floor panels is above the subfloor to define a plenum therebetween;
a supply air duct below the plurality of floor panels;
a supply air register placing the plenum in fluid communication with the comfort zone;
a distribution air duct disposed within the plenum underneath the plurality of floor panels and resting upon the subfloor, the distribution air duct is made of a pliable material such that the distribution air duct is inflatable and collapsible, the distribution air duct includes a proximal end and a distal end, the proximal end is coupled to the supply air duct such that air from the supply air duct passes in series through the proximal end, toward the distal end, out from within the distribution air duct, into the plenum, up through the supply air register, and into the comfort zone; and
a fastener connecting the distal end to a first pedestal of the plurality of pedestals.

10. The air duct system of claim 9, wherein the fastener includes an elongate pliable member.

11. The air duct system of claim 9, wherein the fastener holds the distribution air duct in tension between the supply air duct and the first pedestal.

12. The air duct system of claim 9, wherein the fastener also connects the distal end to a second pedestal of the plurality of pedestals.

13. The air duct system of claim 9, wherein the distal end is an elbow.

14. The air duct system of claim 9, wherein the distal end defines an adjustable opening for exhausting air into the plenum.

15. The air duct system of claim 9, wherein the distribution air duct comprises an upstream tubular wall section adjacent the proximal end and a downstream tubular wall section adjacent the distal end, and the downstream tubular wall section is more air permeable than the upstream tubular wall section.

16. The air duct system of claim 9, further comprising a plurality of decals on an upper surface of the distribution air duct, wherein the plurality of decals are spaced at intervals that are less than a width of each of the plurality of floor panels and wherein the plurality of decals indicate an airflow direction, the plurality of decals are substantially covered by the plurality of floor panels when the plurality of floor panels are supported by the plurality of pedestals.

17. A method of equipping a building with a ventilation system for a comfort zone, wherein the building includes a subfloor, a plurality of pedestals on the subfloor, a plurality of floor panels supported by the plurality of pedestals such that the plurality of floor panels is above the subfloor to define a plenum therebetween, a supply air duct below the plurality of floor panels, and a supply air register on the plurality of floor panels, the method comprising:
defining an assortment of duct segments including a predefined long duct segment and a predefined short duct segment;
after defining the assortment of duct segments, strategically choosing a collection of duct segments from the assortment of duct segments;
assembling the collection of duct segments to create a distribution air duct that is suitable for the building, wherein the distribution air duct is made of a pliable material such that the distribution air duct is inflatable and collapsible, the distribution air duct includes a proximal end and a distal end;
installing the distribution air duct within the plenum, such that the distribution air duct rests upon the subfloor; and
coupling the proximal end to the supply air duct such that air from the supply air duct can pass in series through the proximal end, toward the distal end, out from within the distribution air duct, into the plenum, up through the supply air register, and into the comfort zone.

18. The method of claim 17, wherein the assortment of duct segments includes an elbow.

19. The method of claim 17, wherein the assortment of duct segments includes a right-hand elbow and a left-hand elbow that are distinguishable from each other.

20. The method of claim 17, wherein the assortment of duct segments includes a first duct segment and a second duct segment each having a tubular wall, wherein the tubular wall of the first duct segment is more air permeable than that of the second duct segment.

21. The method of claim 17, wherein the assortment of duct segments includes a distal end segment that defines an adjustable discharge opening.

22. The method of claim 17, further comprising pulling the distribution air duct in tension between the supply air duct and at one pedestal of the plurality of pedestals.

23. The method of claim 17, wherein a standard floor panel of the plurality of floor panels has a standard width, and the predefined long duct segment and the predefined short duct segment each are of a length that is substantially a whole number multiple of the standard width.
